(19) United States
(12) Patent Application Publication
(10) Pub. No.: US 2008/0183498 A1
(43) Pub. Date: Jul. 31, 2008

(54) METHODS AND SYSTEMS FOR SITE STARTUP

(75) Inventors: Gavin D.T. Nichols, Raleigh, NC (US); Sheila Ann Kiss, Maidenhead Berkshire (GB)

Correspondence Address: JOHN S. PRATT, ESQ;KILPATRICK STOCKTON, LLP, 1100 PEACHTREE STREET, ATLANTA, GA, 30309, US

(73) Assignee: Quintiles Transnational Corp., Inc., Durham, NC (US)

(21) Appl. No.: 12/023,313

(22) Filed: Jan. 31, 2008

Related U.S. Application Data
(60) Provisional application No. 60/898,463, filed on Jan. 31, 2007.

(51) Int. Cl. G06Q 50/00; G06Q 10/00

(52) U.S. Cl. 705/2

(57) ABSTRACT

Certain embodiments of the present invention provide clinical site information to clinical trial managers to support clinical trial management. One embodiment is a method for providing information in response to an inquiry. A plurality of site attributes is received. The site attributes can include information regarding the sites that may include clinical trial history, identification, or other site information. Each site attribute includes data elements that are associated with clinical trial sites. A site attribute is identified and a score is determined for each data element of the identified site attribute. An inquiry for clinical trial site information is received. The plurality of data elements are searched to identify at least one clinical trial site based on the inquiry. Information associated with the identified at least one clinical trial site is provided.

### CROSS-REFERENCE TO RELATED APPLICATIONS

This application claims priority to U.S. Provisional Application Ser. No. 60/898,463 filed Jan. 31, 2007, entitled “Methods and Systems for Site Startup,” the entirety of which is incorporated herein by reference.

### FIELD OF THE INVENTION

The present invention relates generally to managing clinical trial processes and, specifically, to increasing efficiency and effectiveness of a site startup process of a clinical trial in the pharmaceutical industry through one of historical information about performance of clinical research associates (CRAs), investigators, other personnel, as well as other attributes.

### BACKGROUND

Clinical trials are often performed to determine the effect a particular drug or medical treatment procedure may have on a particular type of patient or patients in general. Typical clinical trials may involve retaining the services of one or more investigators, such as medical providers or doctors, to administer the drug or medical treatment that is the subject of the clinical trial to a certain number of patients and to obtain and supply data on such patients during or after treatment. Clinical trial managers may establish specific guidelines that the medical provider must follow and employ clinical research associates (CRAs) to oversee or otherwise monitor the investigator during the trial.

Such trials may be wide-spread, encompassing many different investigators and many different types of patients. Clinical trial managers may employ the services of investigators located in different geographical areas to obtain a requisite or preferred number of patients or patient-demographic diversity. CRAs may be required to travel relatively often to the investigators to ensure guidelines are followed, answer any questions the investigators and/or patients may have, or otherwise provide advice and guidance to ensure the clinical trial is implemented correctly and produces useful information.

Managing a clinical trial that produces useful information may depend on, in part, establishing clinical trial sites, managing workloads of CRAs, selecting investigators that can provide the requisite number of patients and offer opportunities for sufficient visits to provide training, information, or other guidance before, during, and after a clinical trial. Often clinical trial managers are unable to easily access sufficient information or attributes regarding proposed clinical sites for clinical trials to analyze such clinical trial sites or investigators before making a selection. Furthermore, clinical trial managers may experience difficulty in managing workloads of CRAs based on a lack of easily accessible information. Accordingly, a need exists for methods and systems for allowing clinical trial managers to make informed selections of clinical trial sites to conduct clinical trials and/or to obtain information necessary to manage such sites, investigators, or CRAs.

### SUMMARY

Certain embodiments of the present invention provide methods and systems for providing historical and other information to clinical trial managers to support clinical trial management. One embodiment is a method for providing clinical trial site information in response to an inquiry. A plurality of site attributes is received. The site attributes can include one or more of a number of patients enrolled within a pre-set time period, transportation hub distance, therapeutic area, and other performance metrics. Each site attribute includes data elements. Each data element is associated with a clinical trial site. A site attribute is identified and a score is determined for each data element of the identified site attribute. An inquiry for clinical trial site information is received. The inquiry includes a data element value. The plurality of data elements are searched to identify at least one clinical trial site based in part on the data element value and the score. Information associated with the identified at least one clinical trial site is outputted.

In some embodiments of the present invention, the site attributes may include at least one of CRA identification, a number of past clinical trials, accuracy, effectiveness and/or timing of results and data, partner status, a number of patients screened for enrollment, patient enrollment goal, and actual patient enrollment.

One embodiment of the present invention is a system for providing clinical trial site information in response to an inquiry. A processor-based device is provided that is adapted to receive site attributes from a site database. Each of the site attributes includes data elements. Each data element is associated with a clinical trial site. The site attributes may include one or more of a number of patients enrolled within a pre-set time period, transportation hub distance, therapeutic area, and other performance metrics. The processor-based device includes a site engine. The site engine is adapted to identify a site attribute, determine a score for each data element of the identified site attribute, receive an inquiry from an input device for clinical trial site information that includes an inquiry value, search the data elements to identify at least one clinical trial site based in part on the inquiry value and the score, and provide a data element associated with the identified at least one clinical trial site to a display device.

These embodiments are mentioned not to limit or define the invention, but to provide examples of embodiments of the invention to aid understanding thereof. Embodiments are discussed in the Detailed Description and advantages offered by various embodiments of the present invention may be further understood by examining the Detailed Description and Drawings.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram illustrating a clinical trial site management system according to one embodiment of the present invention;

FIG. 2 is a flow chart illustrating a method for providing clinical trial site information according to one embodiment of the present invention;

FIG. 3 is a flow chart illustrating a method for determining a score for site attribute data elements using relative scoring according to one embodiment of the present invention;

FIG. 4 is a screen shot of an inquiry for clinical trial site information according to one embodiment of the present invention; and

FIG. 5 is a screen shot of clinical trial site information returned after a search based on an inquiry according to one embodiment of the present invention.

### DETAILED DESCRIPTION

Certain aspects and embodiments of the present invention relate to providing information to clinical trial managers with which they can better manage clinical trials and make an informed selection of clinical trial sites. Clinical trial sites may be a location where an investigator, such as a medical provider or group of medical providers, has an office, meets with patients, or otherwise can conduct its duties associated with a clinical trial. Site data may be associated with each clinical trial site. The site data can include site attributes such as site identification, identification of the CRA associated with the site, transportation hub distance, therapeutic area, surrounding area demographics, and clinical trial history. Clinical trial history can include the number of past clinical trials in which the site participated, relative accuracy, effectiveness and/or timing of results and data provided by the site, number of patients screened for enrollment, patient enrollment goal, actual patient enrollment, speed at which an enrollment goal was reached, and number of patients enrolled within a pre-set time period, such as sixteen months.

Each of the site attributes may include data elements. Each data element may include particular data associated with a clinical trial site. The data elements may be received and used to provide clinical trial managers with information on which they can make an informed selection of clinical trial sites to conduct certain clinical trials and better manage resources for completing a clinical trial.

In some embodiments, data elements of certain site attributes are scored. Scoring data elements may be performed using one or more different methods depending on the particular site attribute. Furthermore, general data may be used to score some data elements. Scoring may include assigning a relative ranking to certain data elements. The score for a data element may be linked to the clinical trial site associated with the data element and stored.

An inquiry may be received that requests clinical trial site information. The inquiry may be based on any type of information. For example, the inquiry may be based on a proposed or planned clinical trial for which sites need to be identified or an inquiry for sites that have performed well during past clinical trials. The inquiry may also or alternatively request identification of sites for which particular CRA's are responsible. The inquiry may include data element values of data elements of selected site attributes and relationships relating a site attribute to the data element value. The data element values can be compared to the stored data elements. Information regarding clinical trial sites that have data elements meeting the data element values and relationships in the inquiry may be returned based on the inquiry. The returned information may be used to identify or select clinical trial sites for one or more clinical trials.

Illustrative System Implementation

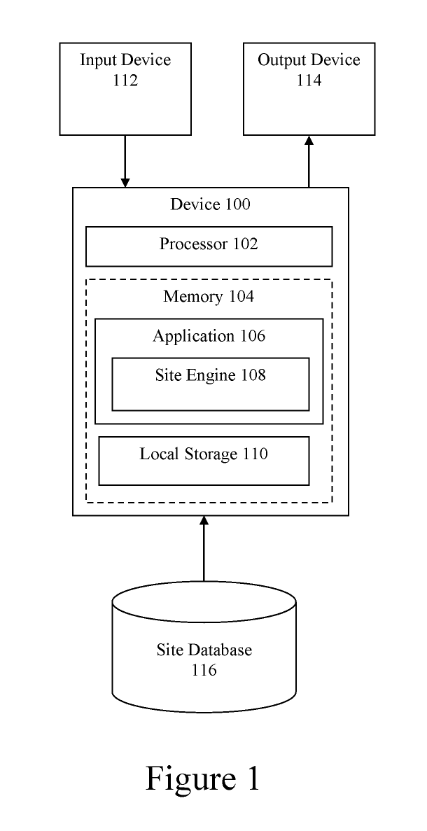

Methods according to various embodiments of the present invention may be implemented on a variety of different systems. An example of one such system is illustrated in FIG. 1. The system includes a processor-based device 100 that includes a processor 102 and a computer-readable medium, such as memory 104. The device 100 may be any type of processor-based device; examples of which include a computer and a server. Memory 104 may be adapted to store computer-executable code and data. Computer-executable code may include an application 106, such as a data management program, that can be used to enter, edit, and view data associated with topics such as clinical trials. The application 106 may include a site engine 108 that, as described in more detail below, may be adapted to perform methods according to various embodiments of the present invention to provide information with which clinical trial sites can be selected. In some embodiments, the site engine 108 may be a separate application that is executable separate from, and optionally concurrent with, application 106.

Memory 104 may also include a local storage 110 that is adapted to store data generated or received by the application 106 or site engine 108, or input by a user. In some embodiments, data storage 110 may be separate from device 100, but connected to the device 100 via wire line or wireless connection.

The device 100 may be in communication with an input device 112 and an output device 114. The input device 112 may be adapted to receive user input and communicate the user input to the device 100. Examples of an input device 112 include a keyboard, mouse, scanner, network connection, and personal computer. User inputs can include commands that cause the processor 102 to execute various functions associated with the application 106 or the site engine 108. In some embodiments, the user may be required to supply authentication credentials to the processor-based device 100 via input device 112 before access to information and tools stored in the processor-based device 100 is granted to the user. The application 106 may receive the credentials from input device 112 and access data in local storage 110 to determine if the credentials match stored credentials and to identify the user.

The output device 114 may be adapted to provide data or visual output from the application 106 or the site engine 108. In some embodiments, the output device 114 can display a visual representation of data associated with clinical sites and provide a graphical user interface (GUI) that includes one or more selectable buttons or other visual inputs that are associated with various functions provided by the application 106 or the site engine 108. Examples of output device 114 include a monitor, network connection, printer, and personal computer.

In some embodiments of the present invention, the processor-based device 100 is a server and the input device 112 and output device 114 together form a second processor-based device such as a personal computer. The personal computer may be in communication with the processor-based device 100 via a network such as an internet or intranet. The site engine 108 may be adapted to send web pages to the personal computer for display and receive communications from the personal computer via the network.

The processor-based device 100 may also be in communication with one or more databases. One database may be a site database 116. The site database 116 may include site data associated with clinical trial sites that can perform a clinical trial. The site data may include site attributes. Each site attribute may include one or more data elements. Each data element contains specific information regarding a clinical trial site. The site attributes can include site identification, identification of the CRA associated with the site, transportation hub distance, therapeutic area, surrounding area demographics, and past clinical trial history. Past clinical trial history can include the number of past clinical trials in which the site participated, relative accuracy, effectiveness, and/or timing of results and data provided by the site, number of patients screened for enrollment, patient enrollment goal, actual patient enrollment, speed at which an enrollment goal was reached, and number of patients enrolled within a pre-set time period, such as sixteen months.

The site database 116 may be connected with the processor-based device 100 via wire line or wireless connection. The processor-based device 100 may communicate with the site database 116 via a network such as an internet or intranet and may be adapted to send and/or receive data from the site database 116. In some embodiments, the site database 116 is a plurality of databases, each storing site data and accessible to the processor-based device 100. In some embodiments, the processor-based device 100 includes the site database 116.

Illustrative Methods for Providing Site Information to Support Selection

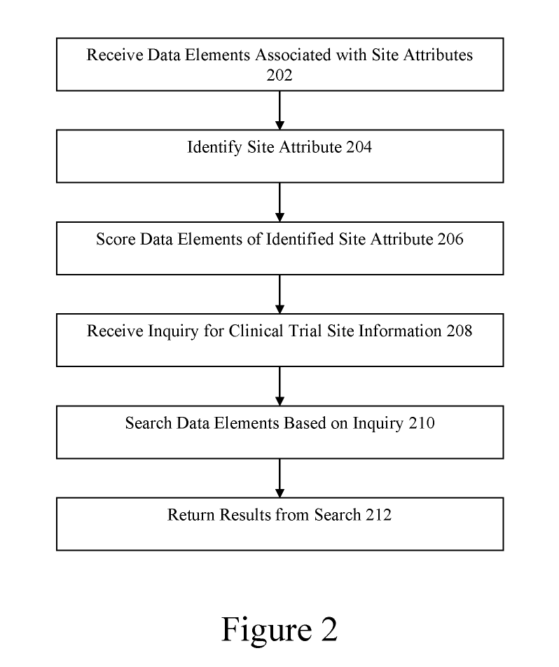

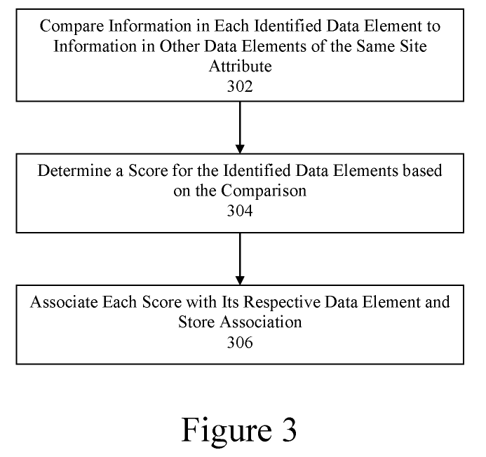

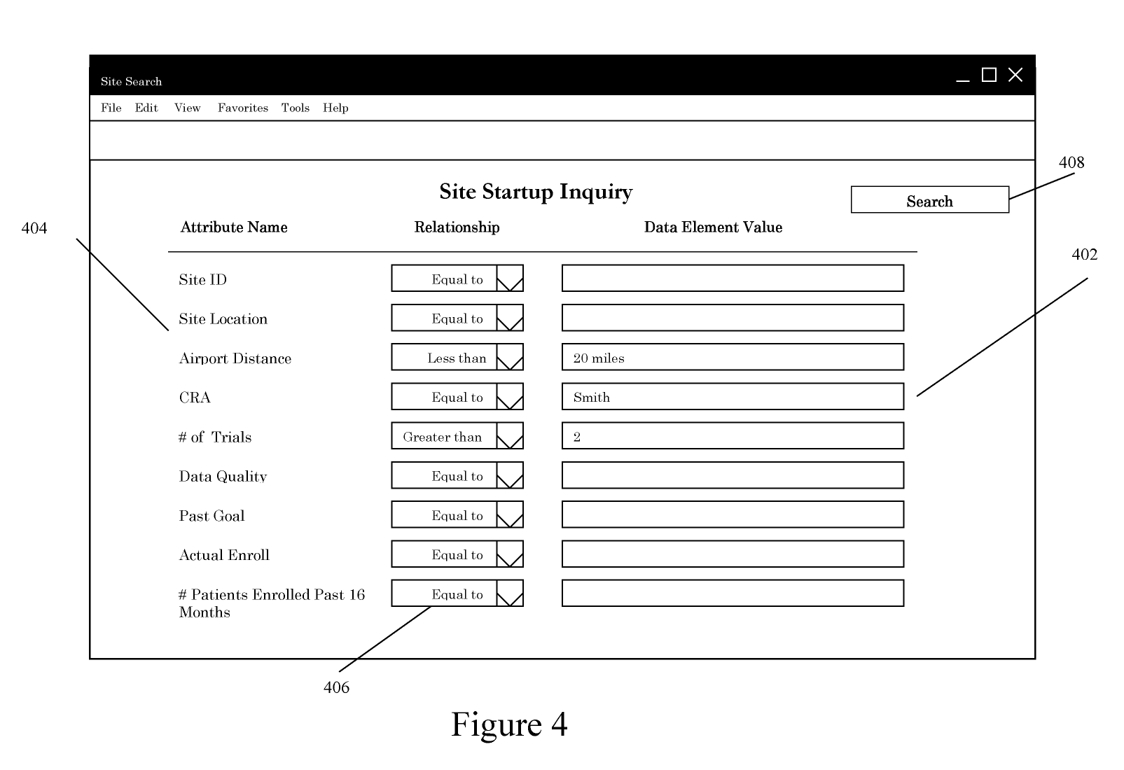

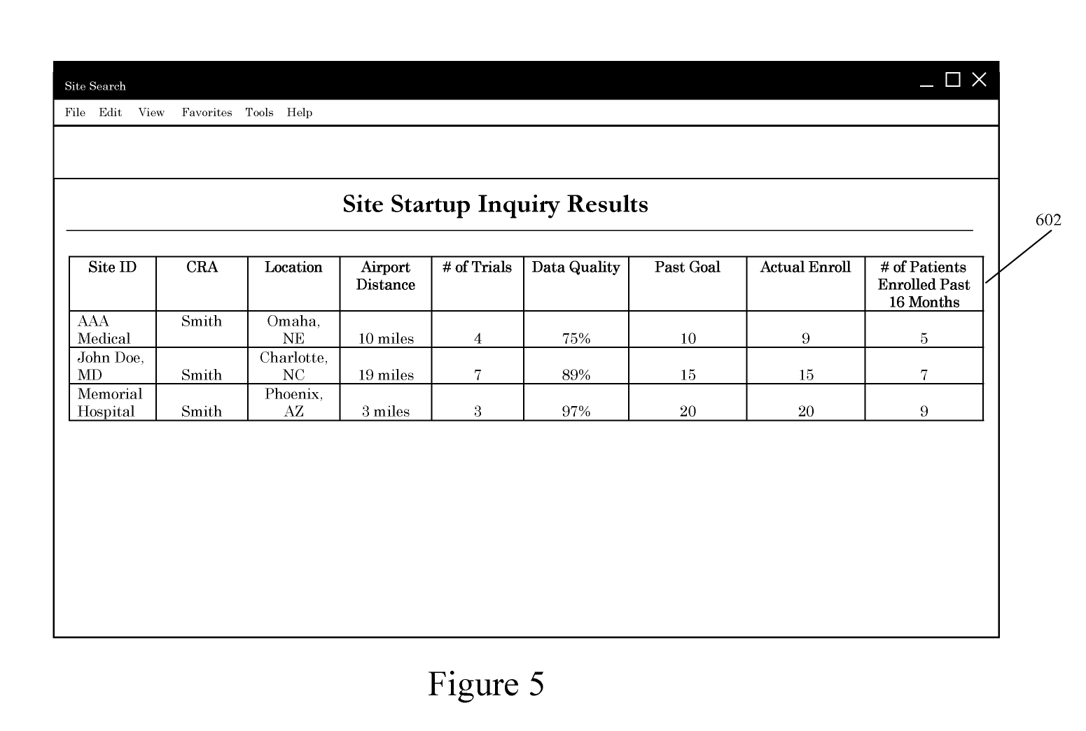

Various methods according to various embodiments of the present invention can be used to provide information to clinical trial managers with which they can manage clinical trials, including making an informed selection of clinical trial sites. FIG. 2 illustrates one embodiment of a method for providing information to clinical trial managers by returning site data based on an inquiry. For purposes of illustration only, the elements of this method are described with reference to the system depicted in FIG. 1, flow chart in FIG. 3, and screen shots in FIGS. 4 and 5. A variety of other implementations are possible.

In block 202, the site engine 108 receives data elements associated with site attributes from the site database 116. Each data element includes information regarding a clinical trial site. In some embodiments, the data elements are grouped into site attributes depending on the nature of the information they contain. Examples of site attributes include site identification, partner status, identification of the CRA associated with the site, therapeutic area, transportation hub distance, surrounding area demographics, and past clinical trial history. The identification of the CRA associated with the site can include a name, number, or other identification of one or more CRAs employed by the clinical trial managers that are responsible for overseeing and managing the site. The transportation hub distance may include a distance between the site's physical location and a transportation hub such as an airport. Surrounding area demographics can include population data associated with a geographical area defined by a pre-set radius surrounding the physical location of the site.

The partner status may indicate whether the clinical trial site has a certain status relative to the clinical trial manager and may include whether the clinical trial site has a working agreement or other relationship with the clinical trial manager. For example, some clinical trial sites may indicate a desire to perform clinical trials or more clinical trials and contact the clinical trial manager to enter into a relationship by requesting assignment to clinical trials. Some of the clinical trial sites may have no other clinical trial experience or other site attribute data which may cause the clinical site manager to select it. The partner status may provide a mechanism with which the clinical trial manager can identify those clinical trial sites who have a continuing interest and willingness to perform clinical trials and, potentially, may be a clinical trial site that the clinical trial manager can train and then work with easily in the future. In some embodiments, the partner status is a positive or negative indicator showing whether the clinical trial site has a partner status. Examples of positive or negative indicators include: yes or no, Y or N, and 1 or 0. Other indicators may signify that no information is available. Examples of such indicators include “null” or “NA”.

The therapeutic area may be a high level identification of diagnoses for patients of a clinical trial site and may indicate a site's level of knowledge of particular therapeutic areas. Clinical trial managers may desire to select clinical trial sites to conduct certain clinical trials based on the type of medical conditions, ailments, or otherwise treated or assessed by the clinical trial site. For example, clinical trial managers may wish to select sites having a certain level of knowledge of a particular therapeutic area for a clinical trial that relates to medical conditions associated with the particular therapeutic area. Clinical trial managers may wish to select a clinical trial site having an oncology therapeutic area to conduct a clinical trial for a cancer drug treatment program. In some embodiments of the present invention, indications, which may include an identification of certain types of diagnoses at a pre-determined abstract level, are grouped into therapeutic areas. Any number of therapeutic areas may be used to group indications. An example of a therapeutic area is oncology. An example of an indication grouped in the oncology therapeutic area is breast cancer. Indentions may include industry standard diagnoses codes such as ICD-9. In preferred embodiments of the present invention, indentions are used that do not specify a diagnoses with the particularity provided by some industry standard codes and, instead, provides a more abstract description of diagnosis types to provide information on which clinical trial sites can be selected without compromising patient privacy or analyzing distinct patient diagnoses.

Clinical trial history can include any type of metrics associated with a site's clinical trial experiences. Examples of clinical trial history include the number of past clinical trials in which the site participated, relative accuracy, effectiveness, and/or timing of results and data provided by the site, number of patients screened for enrollment, patient enrollment goal, actual patient enrollment, speed at which an enrollment goal was reached, and number of patients enrolled within a pre-set time period, such as the past sixteen months. The relative accuracy, effectiveness, and/or timing of results and data provided by the site may include information on the usefulness or accuracy of clinical trial data the site provided. The number of patients screened for enrollment may include a number of people that the site considered for participation in previous clinical trials. The patient enrollment goal may include the number of patients the site was asked to enroll. The actual patient enrollment may include the number of patients actually enrolled. The speed at which an enrollment goal was reached may include the amount of time it took for the site to enroll a pre-set number of patients.

The number of patients enrolled within a pre-set time period, such as sixteen months, may predict the number of patients the site may be able to enroll in the near future. For example, sites that have enrolled patients within a past pre-set time period from the current date may be preferable to sites who have not enrolled patients within the pre-set time period, but who have enrolled large numbers of patients in the more distant past since a site's ability to enroll patients in the relatively recent history can indicate the site's ability to enroll additional patients in the future. Sixteen months is one pre-set time period, but other pre-set time periods may be selected.

Any number of different types of site attributes may be used by various embodiments of the present invention. In some embodiments, all site attributes identified above and, optionally, additional site attributes may be used. In other embodiments, one or more selected site attributes may be used. Data may be unavailable or not requested for some site attributes, or some site attributes may be ignored. In preferred embodiments of the present invention, site attributes associated with the following are used: (1) the number of patients enrolled within a pre-set time period; (2) transportation hub distance; and (3) therapeutic area. The preferred site attributes may be particularly useful for identifying clinical trial sites that can successfully enroll patients in the future, have a requisite level of knowledge in the subject matter of a clinical trial, and are conveniently located relative to a transportation hub such as an airport. In some embodiments, the site engine 108 may be configured to receive site data and select the preferred site attributes. The preferred site attributes may be used individually or in combination and may also be used with other site attributes. In some embodiments, the preferred site attributes also include the partner status site attribute.

Data elements may be received for any number of clinical trial sites and in any format. Examples of formats include extensible markup language (XML) and hypertext markup language (HTML). In some embodiments of the present invention, site engine 108 may send a query for data elements of one or more site attributes to the site database 116 over a network such as an internet. In response to the query, the site database 116 returns data elements of the requested site attributes to the site engine 108 over the network. In other embodiments, the site database 116 periodically sends updated data elements to the site engine 108, where they are stored in local storage 110.

In some embodiments of the present invention, at least some data elements received from the site database 116 may be updated or modified with additional information. The site engine 108 may also be configured to create site attributes using the additional information and existing data elements. The additional information may be general data that is relevant to the site attributes or clinical trials. General data may include any type of data that is not specific to sites. In some embodiments, general data may be information that is relevant to establishing and managing clinical site, but is not particular to individual clinical sites.

Examples of general data include location of transportation hubs, such as airports, and demographic or other population statistics associated with a geographical area. The location of transportation hubs may be helpful in determining which clinical sites to select and establish for conducting a clinical trial. For example, CRAs may be required to physically visit clinical sites relatively often before, during, and/or after a clinical trial period. Clinical sites that are closer to accessible transportation hubs for CRAs may be preferable to clinical sites that are not conveniently located to a transportation hub. Population statistics for a geographical area may also be helpful in selecting a clinical site. Population statistics can include demographic information such as age, sex, and race. Often, clinical trials require a broad range of patient participants from a number of different population metrics. Selecting clinical sites located in a geographical area with a relatively diverse population may be preferable to clinical sites in a geographical area that does not offer as diverse a population.

The site engine 108 identifies general data that is relevant to a site attribute. For example, transportation hub location may be relevant to analyzing the location of clinical trial sites and identified by the site engine 108. The site engine 108 may then identify a specific transportation hub location that is within a pre-set radius of the clinical trial location and determine the distance between it and the site location. The determined transportation distance may be included in a new site attribute as a data element associated with the clinical trial site. In some embodiments, the transportation distance is included in the data element of the site location site attribute. The site engine 108 may receive the general data from any source. An example of one such source is a database or other data storage accessible to the site engine 108 via a network such as an internet or intranet.

In block 204, the site engine 108 identifies site attributes for which to score data elements associated with the identified site attribute. The site engine 108 can be configured to identify all data elements of all site attributes received from site database 116 to score or to identify a subset of the site attributes and only score data elements associated with the subset of site attributes. For example, the site engine 108 may be configured to identify one or more preferred site attributes to score, such as the number of patients enrolled within a pre-set time period, transportation hub distance, therapeutic area, and, optionally, partner status.

In block 206, the site engine 108 scores each data element of the identified site attribute. Data elements may be scored by any method. Furthermore, some data elements of certain site attributes may be scored using a first method and data elements of other site attributes may be scoring using a second method. An example of one method is a relative scoring method shown in FIG. 3.

The relative scoring method may begin in block 302 when the site engine 108 compares the information in each identified data element to the information in other identified data elements of the same site attribute. For example, the site engine 108 may identify data elements of the transportation hub distance site attribute as the data elements to score. The site engine 108 compares information in a data element for one clinical trial site to information in data elements of the transportation hub distance site attributes for all other clinical trial sites.

In block 304, the site engine 108 determines a score for each identified data element based on the comparison. In some embodiments, the site engine 108 assigns a score indicator, such as a number, letter, color, or otherwise, to each data element based on the comparison. The site engine 108 may be configured to perform any scoring determination method to assign a score indicator. An example of one scoring determination method includes determining a number rank of each identified data element based on information in other data elements of the same site attribute. For example, a number rank of “one” may be determined for the data element having the relative “best” or most preferred information compared to other data elements of the same site attribute a number rank of “two” determined for the data element having the next “best” or most preferred information. The relative ranking may continue until the site engine 108 determines a number rank to each data element of a site attribute. In some embodiments, data elements that have the same information, such as in cases of a tie, may receive the same number rank. A data element may be created for clinical trial sites for which data elements are not available for a particular site attribute that includes a score indicator showing no data was available. An example of one such ranking may be the initials “NA” indicating no available data.

In block 306, the site engine 108 associates or links the scores with their respective data elements and stores the association in local storage 110. The data elements including the scores may be available to the site engine 108 for future uses as described in more detail below.

The site engine 108 may repeat the relative scoring method for data elements of other site attributes. The site engine 108 may be configured to perform the relative scoring method for data elements of certain site attributes and another scoring method for data elements of other site attributes.

In some embodiments, the site engine 108 scores data elements using statistical records. The site engine 108 may compare information in data elements of selected site attributes to statistical records or pre-set data to determine a score to assign to the data elements. The statistical records may be statistics regarding average site attribute information. In some embodiments, the statistical records include average site attribute information for a selected geographical area. The pre-set data may be data previously provided to the site engine 108 that relates to preferred, average, and non-preferred information or values for the particular site attribute. An example of statistical records includes the average distance from a transportation hub that selected businesses or other entities, such as clinical trial sites, may be located in a geographical area. Examples of pre-set data include a preferred distance between clinical trial sites and a transportation hub, distances considered generally acceptable but less preferred, and distances that are not preferred. In some embodiments, the pre-set data may be provided to the processor-based device 100 via input device 112. The score may be any indicator signifying the association of the information in data elements of site attributes for which the statistical records pertain to statistical averages or preferred, average, or non-preferred data. Examples of indicators number numbers, letters, and percentages.

Returning to FIG. 2, the site engine 108 may receive an inquiry for clinical trial site information from input device 112 in block 208. The inquiry may request an identification of clinical trial sites based on one or more site attributes and data element values. In some embodiments, the inquiry may be received from input device 112 over a network. For example, the site engine 108 may be configured to send an inquiry page to output device 114 for display to the user. The inquiry page may include an area in which the user can enter the inquiry using input device 112. In some embodiments, the inquiry page includes selectable buttons that the user may select to form an inquiry.

A user may access a web browser application on a personal computer and enter a network address for a site startup website. A log-in page for the site startup website may be sent to the personal computer from the server. The user enters their username and password into the log-in page and sends it to the server for authentication. After authenticating the user, the server may send an inquiry page that is a web page. One embodiment of an inquiry page that may be provided to the user is shown in FIG. 4. The inquiry page may include one or more fields 402, where each of the fields 402 may be associated with an attribute name 404, such as a site attribute or other site data. The site attributes listed can include site identification, identification of the CRA associated with the site, transportation hub distance, surrounding area demographics, the number of past clinical trials in which the site participated, relative accuracy, effectiveness, and/or timing of results and data provided by the site, number of patients screened for enrollment, patient enrollment goal, actual patient enrollment, speed at which an enrollment goal was reached, number of patients enrolled within a pre-set time period, such as sixteen months, therapeutic area, and partner status. In some embodiments, the site attributes listed include at least one of the preferred site attributes.

The user may enter a data element value into fields 402. Each of the fields 402 is associated with a site attribute. The data element value may be particular information associated with the site attribute. The user may also select a relationship in selectable menus 406 and form an inquiry that is a request for a search for clinical trial sites with data elements having information that meet the attribute value and relationship. Examples of relationships include equal to, greater than, and less than. The inquiry shown in FIG. 4 includes a request for sites that are less than twenty miles from an airport, associated with CRA identified as Smith, and performed more than two clinical trials. The user may select the search button 408 to cause the inquiry to be sent to the site engine 108. The site engine 108 may receive the inquiry and determine the data element values and relationships included in the search.

In block 210 of FIG. 2, the site engine 108 performs a search based on the inquiry. The site engine 108 may search data elements of site attributes identified by the inquiry to identify clinical trial sites with data element information that meet the attribute values and relationships included in the inquiry. For example, the site engine 108 may search for sites that are less than twenty miles from an airport, associated with a CRA identified as Smith, and performed more than two clinical trials. In some embodiments, the site engine 108 searches data stored in local storage 110 to identify clinical trial sites that meet the data element values and relationships.

In block 212, the site engine 108 returns results of the search to the user. The site engine 108 may send the results to output device 114 for display to the user. For example, the site engine 108 may return the results in a web page. One embodiment of results returned to the user as a web page is shown in FIG. 5. The web page may include a table 502 identifying site attributes and information for each site attribute. The information is associated with clinical trial sites having data elements that meet the inquiry. The table 502 may include all available site attributes associated with one or more clinical trial sites. In some embodiments, the results may only include a site identification and site attributes included in the inquiry.

Various embodiments of the present invention may be used to search clinical trial site information of interest to clinical trial managers for managing clinical trials. The user may cause a search to be performed using any data element value of one or more site attributes that may be relevant to proposed clinical trials. Search results may provide clinical trial managers with necessary information to select preferred clinical trial sites based on selected site attributes and to better manage personnel, such as CRAs, responsible for clinical trial sites.

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention.

What is claimed is:

1. A method for managing a clinical trial comprising:
receiving a plurality of clinical trial site attributes, each of the plurality of site attributes having a plurality of data elements, each data element being associated with a clinical trial site, wherein the site attributes comprise information regarding at least one of:
number of patients enrolled within a pre-set time period;
transportation hub distance; and
therapeutic area;
identifying at least one site attribute;
determining a score for each data element of the at least one identified site attribute;
receiving an inquiry for clinical trial site information, the inquiry comprising at least one data element value;
searching the plurality of data elements to identify at least one clinical trial site appropriate to consider for the clinical trial based in part on the data element value and the score; and
outputting information associated with the identified at least one clinical trial site.

2. The method of claim 1, wherein determining the score for each data element of the identified at least one site attribute comprises:
determining the score based on a comparison of information of each data element; and
assigning an indicator to each data element based on the score.

3. The method of claim 1, wherein determining the score for each data element of the at least one identified site attribute comprises:
determining the score based on a statistical record; and
assigning an indicator to each data element based on the score.

4. The method of claim 3, wherein the statistical record comprises statistics regarding average information for the identified site attribute.

5. The method of claim 1, further comprising:
authenticating a user; and
providing an inquiry page to the user.

6. The method of claim 1, further comprising:
receiving general information; and
generating a plurality of data elements for a first site attribute using the general information and data elements of a second site attribute.

7. The method of claim 1, wherein the site attributes further comprise information about at least one of:
Clinical Research Associate (CRA) identification;
number of past clinical trials;
accuracy of results;
number of patients screened for enrollment;
partner status;
patient enrollment goal; and
actual patient enrollment.

8. The method of claim 1, wherein the outputted information comprises site identification and at least one of:
CRA identification;
transportation hub distance;
number of past clinical trials;
accuracy of results;
number of patients screened for enrollment;
therapeutic area;
number of patients enrolled within a pre-set time period;
partner status;
patient enrollment goal; and
actual patient enrollment.

9. A system for managing a clinical trial, the system comprising:
a processor-based device adapted to receive a plurality of clinical trial site attributes from a site database, each of the plurality of site attributes having a plurality of data elements, each data element being associated with a clinical trial site, wherein the site attributes comprise information regarding a number of patients enrolled within a pre-set time period;
wherein the processor-based device comprises a site engine adapted to:
identify at least one site attribute;
determine a score for each data element of the at least one identified site attribute;
receive an inquiry for clinical trial site information from an input device, the inquiry comprising at least one data element value;
search the plurality of data elements to identify at least one clinical trial site appropriate to consider for the clinical trial based in part on the data element value and the score; and
output information associated with the identified at least one clinical trial site to an output device.

10. The system of claim 9, wherein the site engine determines the score for each data element of the identified at least one site attribute by:
determining the score based on a comparison of information of each data element; and
assigning an indicator to each data element based on the score.

11. The system of claim 9, wherein the site engine determines the score for each data element of the identified at least one site attribute by:
determining the score based on a statistical record; and
assigning an indicator to each data element based on the score.

12. The system of claim 1 1, wherein the statistical record comprises statistics regarding average information for the identified site attribute.

13. The system of claim 9, wherein the site engine is adapted to authenticate a user and provide an inquiry page to the output device.

14. The system of claim 9, wherein the site engine is adapted to:
receive general information; and
generate a plurality of data elements for a first site attribute using the general information and data elements of a second site attribute.

15. The system of claim 9, wherein the site attributes further comprise information about at least one of:
Clinical Research Associate (CRA) identification;
number of past clinical trials;
accuracy of results;
number of patients screened for enrollment;
partner status;
patient enrollment goal;
actual patient enrollment;
transportation hub distance; and
therapeutic area.

16. The system of claim 9, wherein the outputted information comprises site identification and at least one of:
CRA identification;
transportation hub distance;
number of past clinical trials;
accuracy of results;
number of patients screened for enrollment;
therapeutic area;
number of patients enrolled within a pre-set time period;
partner status;
patient enrollment goal; and
actual patient enrollment.

17. A computer-readable medium on which is program code for managing a clinical trial, the computer-readable medium comprising:
program code for receiving a plurality of clinical trial site attributes, each of the plurality of site attributes having a plurality of data elements, each data element being associated with a clinical trial site, wherein the site attributes comprise information regarding:
number of patients enrolled within a pre-set time period;
transportation hub distance; and
therapeutic area;
program code for identifying at least one site attribute;
program code for determining a score for each data element of the at least one identified site attribute;
program code for receiving an inquiry for clinical trial site information, the inquiry comprising at least one data element value;
program code for searching the plurality of data elements to identify at least one clinical trial site appropriate to consider for the clinical trial based in part on the data element value and the score; and
program code for outputting information associated with the identified at least one clinical trial site.

18. The computer-readable medium of claim 17, wherein program code for determining the score for each data element of the identified at least one site attribute comprises:
program code for determining the score based on a comparison of information of each data element; and
program code for assigning an indicator to each data element based on the score.

19. The computer-readable medium of claim 17, wherein program code for determining the score for each data element of the at least one identified site attribute comprises:
program code for determining the score based on a statistical record; and
program code for assigning an indicator to each data element based on the score.

20. The computer-readable medium of claim 19, wherein the statistical record comprises statistics regarding average information for the identified site attribute.

21. The computer-readable medium of claim 17, further comprising:
program code for authenticating a user; and
program code for providing an inquiry page to the user.

22. The computer-readable medium of claim 17, further comprising:
program code for receiving general information; and
program code for generating a plurality of data elements for a first site attribute using the general information and data elements of a second site attribute.

23. The computer-readable medium of claim 17, wherein the site attributes further comprise information about at least one of:
Clinical Research Associate (CRA) identification;
number of past clinical trials;
accuracy of results;
number of patients screened for enrollment;
partner status;
patient enrollment goal; and
actual patient enrollment;

24. The computer-readable medium of claim 17, wherein the outputted information comprises site identification and at least one of:
CRA identification;
transportation hub distance;
number of past clinical trials;
accuracy of results;
number of patients screened for enrollment;
number of patients enrolled within a pre-set time period;
therapeutic area;
partner status;
patient enrollment goal; and
actual patient enrollment.
